(19) United States
(12) Patent Application Publication
(10) Pub. No.: US 2009/0203431 A1
(43) Pub. Date: Aug. 13, 2009

(54) MULTIPLE GAME SERVER SYSTEM

(76) Inventor: Daniel Bernesi, L'ile Bizard (CA)

Correspondence Address: GOUDREAU GAGE DUBUC, 2000 MCGILL COLLEGE, SUITE 2200, MONTREAL, QC, H3A 3H3, CA

(21) Appl. No.: 12/305,132

(22) PCT Filed: Jun. 18, 2007
(86) PCT No.: PCT/CA2007/001073

§ 371 Date: Dec. 16, 2008

Related U.S. Application Data
(60) Provisional application No. 60/814,084, filed on Jun. 16, 2006.

(51) Int. Cl. G06F 17/00

(52) U.S. Cl. 463/25; 463/43; 463/42

(57) ABSTRACT

A system for selecting and playing a game on at least one existing game console (1). The system includes a handling device (20) for automatically loading and unloading a game medium (16) into the game console; and a controller (4) for sending control commands to the handling device (20) and the game console (1) to selectively load and unload the game medium chosen by a user into the game console (1).

### FIELD OF THE INVENTION

The present invention relates to game console for playing video games.

### BACKGROUND OF THE INVENTION

Known in the art, there are several game consoles such as Microsoft X-Box™, Sony Playstation™, Nintendo™ and others that are used to play a number of different games on DVD cartridge or other storage methods.

It has been a long felt need by arcade operators to be able to use such above-identified game consoles in their premises in exchange of payment by users for playing on such game consoles. However, these game consoles use proprietary software or firmware and any modification to the hardware and/or software of such game consoles may give rise to intellectual property and/or patent infringement issues.

There is therefore a need for a system that may use an existing game console in different environments, such as in an arcade, without having to make internal hardware and/or software modification of such game console.

### SUMMARY OF THE INVENTION

According to the present invention, there is provided a system for selecting and playing a game on at least one existing game console, the system comprising:

a handling device for automatically loading and unloading a game medium into the game console; and

a controller for sending control commands to the handling device and the game console to selectively load and unload the game medium chosen by a user into the game console.

Preferably, a system according to the present invention allows one to use a game console, such as Microsoft X-Box™, Sony Playstation™, Nintendo™ and others to select and play a number of different games on DVD cartridge or other storage methods.

Preferably, the system may operate multiple game consoles within the same enclosure, thus allowing the user to select the game console type (X-Box™ or Playstation™ for example) and then select which game to play.

The user may pay a fee to use the system. The fee may be paid using a Coin or Currency Bill acceptor, Credit Card, Prepaid cards or other suitable form of payment.

The operation and game selection is transparent to the game console operation, and does not require any proprietary software or firmware or mechanical modification of the original game consoles, given the fact that any reverse engineering of the original software or firmware could be considered an intellectual property and/or patent infringement.

These and other objects and advantages of the invention will become apparent upon reading the detailed description and upon referring to the appended drawings.

### BRIEF DESCRIPTION OF THE DRAWING

FIG. 1 is a block diagram of a multiple game server system, according to a preferred embodiment of the present invention.

FIG. 2 is a side view of a handling device that may be used with an existing game console, according to a preferred embodiment of the present invention.

FIG. 3 is a top view of a rotatable tray of the handling device shown in FIG. 2.

### DESCRIPTION OF PREFERRED EMBODIMENTS

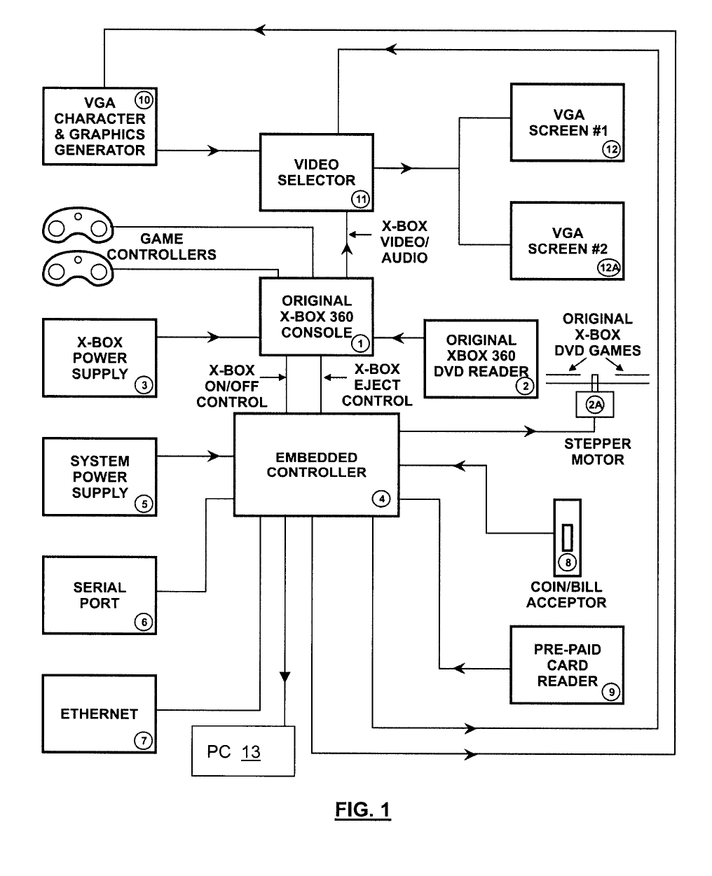

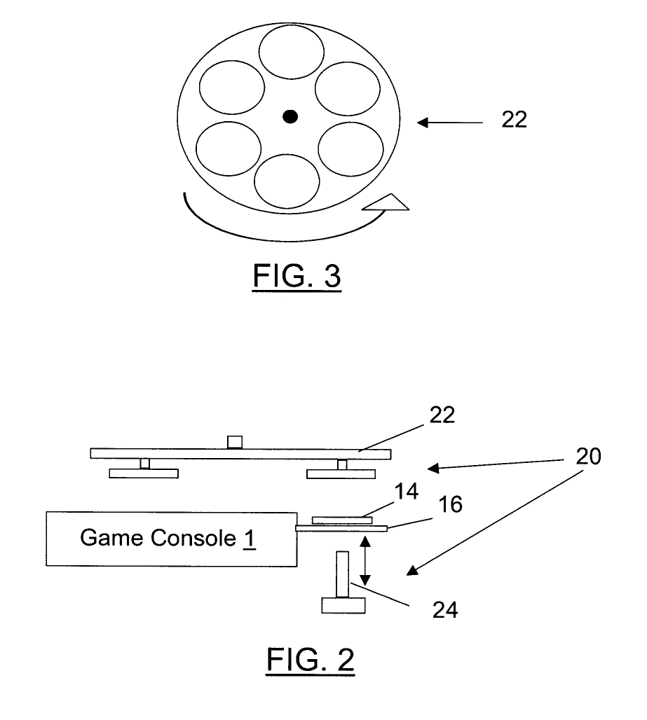

Referring to FIG. 1, there is shown a system for selecting and playing a game on an existing game console 1, according to a preferred embodiment of the present invention. The system includes a handling device 20, an example of which is shown in FIGS. 2 and 3, for automatically loading and unloading a game medium 14, such as a DVD disk, into the game console 1. The system also includes a controller 4 for sending control commands to the handling device 20, which may include for example a stepper motor 2A, and also to the game console 1, to selectively load and unload the game medium chosen by a user into the game console 1.

Referring to FIGS. 2 and 3, the handling device 20 may include a rotatable tray 22 for holding the disks and selectively releasing one of the disks above an open disk tray 16 of the game console 1. The handling device may also include a robotic device 24 cooperating with the rotatable tray 22 for removing said one disk from the rotatable tray 22, positioning said one disk onto the open tray 16 of the game console 1, and pushing said one disk back onto the rotatable tray 22.

Of course, other means for holding and selecting a number of DVD's may be used, as will be understood by persons skilled in the art.

Referring back to FIG. 1, the controller 4 may be an embedded controller with custom firmware that controls the system operation. Preferably, The X-Box™ game console 1 is powered by its original power supply 3 and the rest of the system is powered by the system power supply 5.

Preferably, the game console 1 is a Microsoft X-Box 360™ game console. However, any other game console such as Sony Playstation™ or Nintendo™ may be used. The original X-Box 360™ game console 1 with game controllers and the original X-Box 360™ DVD reader 2 are controlled by the embedded controller 4. The control commands sent by the embedded controller 4 are emulations of the standard infrared signals sent by a remote control of the game console 4, such as the ON/OFF control command and the DISK EJECT control command.

The system is thus controlled by the custom made embedded controller 4 that emulates the game console commands by means of isolated switches such as Power On-Off, DVD Eject, or infrared command sequences, etc.

Preferably, the embedded controller 4 also controls a VGA character and graphics generator 10 and a video selector 11 that switches between the Games available screen, Price screen, Commercials, Advertisement and the actual X-Box generated video. The embedded controller 4 may also control a PC 13 that may be used to play video trailers of the games and/or product adverting. The Video Selector 11 is able to drive two internal back-to-back VGA screens 12, 12A and also external screens. Of course any other suitable means may be used to display the game being played and other information.

The same VGA screens 12, 12A or other suitable means are used to display the games available, playing instructions, price structure, commercial and/or local advertising and promotions other information.

Preferably, upon accepting payment from a Coin/Bill acceptor 8, a Pre-paid card reader 9 or other payment method, the embedded controller 4 prompts the user to select a game to play. The embedded controller 4 then loads the selected game from the DVD turntable or rotatable tray 22 by rotating the stepper motor 2A to the proper position. The embedded controller 4 then starts the game using the X-Box™ game console on/off and eject/load controls.

Preferably, the embedded controller 4 is connected to a serial port 6 for maintenance and updates. The embedded controller 4 may also be connected to an Ethernet port 7 and/or phone modem to allow network and Internet access to the system.

Preferably, the system includes a timer that displays the remaining playing time either on a separate display or on an overlaid video on the game screen.

Preferably, the system includes a means of connecting an external computer to download from the system information such as number and name of games played, amount of money received and other suitable information. The same external computer will be able to upload to the system game names, pricing structure, playing times and other suitable information.

Preferably, the system includes an audio amplifier and speakers to play the game audio.

Preferably, the system includes an optional Ethernet connector and/or phone modem that allows remote configuration, commercial and/or local advertising and promotions.

### Operation

Preferably, in its idle state, the system continuously runs in a loop where Game names, Game description, price structure and other information is displayed. Within the same loop, commercial and/or local advertising, promotions and/or special events are displayed.

Preferably, in one particular embodiment, the user inserts coins to pay for a predetermined amount of playing time. Then, upon acceptance of payment, the system displays the games that may be selected and the allowed playing time. Thereafter, the user selects a game and plays such game for the allowed playing time. Finally, when the allowed playing time expires the system returns to the idle state.

The system according to the present invention controls the game consoles, such as Microsoft X-Box™, Sony Playstation™, Nintendo™ and others without modifying or reverse engineering the original console software or firmware.

Preferably, besides selecting and playing multiple games on existing Game Consoles such as Microsoft X-Box™, Sony Playstation™, Nintendo™ and others, the system allows the display of commercial and/or local advertising, promotions and/or special events.

Preferably, the system includes means of uploading via an Ethernet connection remote configuration and/or phone modem, commercial and/or local advertising and promotions as well as downloading game statistical data.

Preferably, the system includes means to control a PC 13 to display video trailers of the games being offered and/or display videos for the purpose of product advertising and/or promotions.

Although a preferred embodiment of the present invention has been described in detail herein and illustrated in the accompanying drawing, it is to be understood that the invention is not limited to this precise embodiment and that various changes and modifications may be effected therein without departing from the scope or spirit of the present invention.

1. A system for selecting and playing a game on at least one existing game console (1), the system comprising:
a handling device (20) for automatically loading and unloading a game medium (16) into the game console (1); and
a controller (4) for sending control commands to the handling device (20) and the game console (1) to selectively load and unload the game medium chosen by a user into the game console (1), wherein the control commands sent by the controller (4) to the game console (1) are emulations of standard infrared signals sent by a remote control of the game console (4).

2. The system of claim 1, wherein game medium (14) includes a set of disks and the handling device (20) includes:
a rotatable tray (22) for holding the disks and selectively releasing one of the disks above an open disk tray (16) of the game console (1), and
a robotic device (24) cooperating with the rotatable tray (22) for removing said one disk from the rotatable tray (22), positioning said one disk onto the open tray (16) of the game console (1), and pushing said one disk back onto the rotatable tray (22).

3. The system of claim 1, wherein the controller (4) is connected to a coin/bill acceptor (8) or pre-paid card reader (9) for authorizing a user to select a game to play.

4. The system of claim 1, wherein the controller (4) is connected to a VGA character and graphics generator (10) and a video selector (11), the video selector being connected to at least one VGA screen (12, 12A), for switching between screen indicia.

5. The system of claim 1, wherein the screen indicia include a games available screen, price screen, commercials, advertisement and actual game console generated video.

6. The system of claim 1, wherein the controller (4) is connected to a PC (13) for playing video trailers of games being offered and/or product advertising and/or promotions.

7. The system of claim 1, wherein the controller (4) is connected to a serial port (6) for providing maintenance and updates of the system.

8. The system of claim 1, wherein the controller (4) is connected to an Ethernet port (7) and/or phone modem for providing network and Internet access to the system.

9. The system of claim 1, wherein the controller (4) is connected to an Ethernet port (7) and/or phone modem and is adapted to upload commercial and/or local advertising and promotions as well as downloading game statistical data.

10. The system of claim 1, wherein the standard infrared signals include an on/off control command and a disk eject control command.
